(19) United States
(12) Patent Application Publication
(10) Pub. No.: US 2009/0035184 A1
(43) Pub. Date: Feb. 5, 2009

(54) HYDROGEN GAS SENSOR

(76) Inventors: Hiroshi Koda, Sanda-shi (JP); Kazuyasu Iida, Kobe-shi (JP)

Correspondence Address: Cheng Law Group, PLLC, 1100 17th Street, N.W., Suite 503, Washington, DC, 20036, US

(21) Appl. No.: 12/280,986

(22) PCT Filed: Feb. 27, 2007
(86) PCT No.: PCT/JP2007/053590

§ 371 Date: Oct. 21, 2008

(30) Foreign Application Priority Data
Feb. 27, 2006 (JP) PCT/JP2006/303617

(51) Int. Cl. G01N 31/12

(52) U.S. Cl. 422/94

(57) ABSTRACT

The present invention provides a catalytic combustion type hydrogen gas sensor of a simple structure, which is capable of inhibiting the degradation of the sensitivity thereof over a long period of time even in the presence of a silicon compound being a catalyst poison. This hydrogen gas sensor is equipped with a detection element 1 having a sensing part 2 and a silicon trapping body 3. The sensing part 2 has a function of being heated by Joule heat generated by energization of the sensing part 2, a function of combusting hydrogen gas while being heated, and a function of outputting a change in electrical resistance of the sensing part 2 indicative of hydrogen gas concentration, the change in electrical resistance being caused by an increase in temperature of the sensing part 2 caused by the combustion heat of the hydrogen gas. The silicon trapping body 3 covering the sensing part 2 contains a silicon-trapping material that functions to trap a silicon compound from a gaseous matter passing through the silicon trapping body 3.

### TECHNICAL FIELD

The present invention relates to a catalytic combustion type hydrogen gas sensor which is used for detecting hydrogen gas.

### PRIOR ART

A semiconductor type or catalytic combustion type gas sensor is widely known as a conventional hydrogen gas sensor for detecting the hydrogen concentration in the atmosphere. Especially the catalytic combustion type gas sensor, a sensor for converting reaction heat generated due to combustion of combustible gas on a sensor surface into an electric signal, is characterized by having a simple structure and linear characteristics of output signals.

FIG. 8 shows a conventional catalytic combustion type gas sensor disclosed in Japanese Patent Application Publication H10-90210. A detection element 21 of this gas sensor is configured by a combustor 22 for combusting combustible gas and a heating resistor 23 for heating the combustor 22 with Joule heat generated in accordance with energization of the combustor 22.

The combustor 22 is formed of an insulating material such as alumina into a bead, which contains a catalyst such as palladium or platinum. The heating resistor 23 is configured mainly by a platinum wire having a high-temperature resistance coefficient. This heating resistor 23 is coiled up, and the coiled part is embedded in the combustor 22.

In this type of detection element 21, substantially constant amount of current is fed to the heating resistor 23, and the combustor 22 is heated at a constant temperature by means of the Joule heat generated in the heating resistor 23. When the combustible gas is combusted on a surface of the combustor 22, the temperature of the heating resistor 23 is increased due to this combustion heat, thereby changing the resistance value of the heating resistor 23. The combustible gas can be detected from this change in resistance value.

This type of detection element 21 is produced by the following general method. First, a platinum wire of approximately 20 to 50 μm diameter is coiled up to make the heating resistor 23. Next, a ceramic carrier composed mainly of an inorganic insulator such as alumina is processed into a sol or a paste, which is then applied to the coiled part of the heating resistor 23 so as to form an elliptical shape and then heated to form the combustor 22 into a bead. Thereafter, the combustor body 22 is impregnated with a catalyst such as platinum or palladium, which is then heated to obtain the detection element 21 in which the alumina carrier carries the catalyst in a highly dispersed state.

Incidentally, in recent years, hydrogen is receiving particular attention as an alternative energy source to oil, and hence the development of fuel-cell vehicle is promoted. Such a fuel-cell vehicle needs to be installed with one or a plurality of hydrogen gas sensors for detecting leakage of hydrogen from the fuel cell or hydrogen tank of the fuel-cell vehicle. The use of the above-described catalytic combustion type gas sensor as this hydrogen gas sensor is therefore considered.

However, it is known that when vapor of a silicon compound being a catalyst poison is present in the atmosphere where the gas sensor is used, the catalyst becomes poisoned, leading to a change in the characteristics of the gas sensor. On the other hand, a silicon product such as a silicon packing is used in the fuel cell. Therefore, the problem in the hydrogen gas sensor for a fuel cell is that the sensitivity of the hydrogen gas sensor is reduced due to the silicon compound. Particularly because a catalytic combustion type gas sensor combusts gas by means of a catalyst and detects the gas, it is known that the catalytic activity is reduced by a small amount of silicon compound as well, leading to a significant decrease in the sensitivity of the gas sensor.

Therefore, in order to prevent the sensitivity reduction caused by the silicon compound, activated carbon capable of absorbing a silicon compound has conventionally been used. Japanese Patent Application Publication No. 2004-02077 discloses a general use of a net which is tensioned in a passage of introducing a target gas to a gas sensor. The net carries activated carbon and forms a filter for absorbing silicone compounds for removal thereof.

However, due to a large ventilation resistance of this filter configured by the activated carbon, the amount of a target detection gas flowing into the gas sensor is reduced, causing the degradation of detection sensitivity. Also, the net or other member is required to hold the activated carbon, which leads to a cost increase. Moreover, there are management problems of requiring management of the amount of activated carbon held on the net or the like and requiring management of the net or the like for holding the activated carbon. In addition, there is a quality problem that the fine granular activated carbon that fell off the net or the like adheres to the detection element 21.

Also, as disclosed in Japanese Patent Application Publication No. 2002-137648, it is considered that a silicon-trapping material is applied to an inner wall of an introducing passage for introducing the target gas to the gas sensor, or to the surfaces of a plurality of baffles provided in this introducing passage. This idea, however, makes the structure of the gas sensor complicated, and there is a large amount of gas that flows into the gas sensor without coming into contact with the inner wall or baffles of the introducing passage; which makes it impossible to expect sufficient removal of the silicon compound.

### DISCLOSURE OF THE INVENTION

The present invention has been contrived in order to solve the problems above, and an object of the present invention is to provide a catalytic combustion type hydrogen gas sensor of a simple structure, which is capable of inhibiting the degradation of the sensitivity thereof over a long period of time even in the presence of a silicon compound being a catalyst poison.

The hydrogen gas sensor according to the present invention is a catalytic combustion type hydrogen gas sensor. This hydrogen gas sensor is equipped with a detection element 1 having a sensing part 2 and a silicon trapping body 3. The sensing part 2 has a function of being heated by Joule heat generated by energization of the sensing part 2, a function of combusting hydrogen gas while being heated, and a function of outputting a change in electrical resistance of the sensing part 2 indicative of a hydrogen gas concentration, the change in electrical resistance being caused by an increase in temperature of the sensing part 2 caused by the combustion heat of the hydrogen gas. The silicon trapping body 3 covering the sensing part 2 contains a silicon-trapping material. The silicon-trapping material functions to trap a silicon compound from a gaseous matter passing through the silicon trapping body 3.

According to the present invention, when the detection element 1 is exposed to a target detection gas, the target gas passes through the silicon trapping body 3 before reaching the sensing part 2. The silicon compound contained in the target gas is trapped by the silicon trapping body 3 and removed from the target gas. Therefore, the sensing part 2 can be prevented from being poisoned by the silicon compound being a catalyst poison, and the degradation of the sensitivity of the hydrogen gas sensor can be inhibited over a long period of time even in the presence of the silicon compound. Because the target gas that reaches the sensing part 2 entirely passes through the silicon trapping body 3, the silicon compound can be securely removed. Also, because the detection element 1 is equipped the silicon trapping body 3, it is unnecessary to remove the silicon compound from the target gas before exposing the detection element 1 to the target gas. For this reason, the sensing part 2 can be inhibited from being poisoned with the silicon compound in a convenient configuration without other equipment for removing the silicon compound from the target gas.

It is preferred that the sensing part is a heating resistor which consists of a noble metal coil having a hydrogen combustion catalytic activity surface. In this case, hydrogen gas can be combusted on the surface of the heating resistor 4, and a change in electrical resistance of the heating resistor 4 can be caused by increase in temperature of the heating resistor 4 caused by the combustion heat of the hydrogen gas, and the sensing part 2 can output the change in electrical resistance of the sensing part 2 indicative of a hydrogen gas concentration.

It is preferred that the silicon trapping body 3 contains platinum as the silicon-trapping material. It is also preferred that the silicon trapping body 3 contains activated carbon as the silicon-trapping material. In these cases, with these silicon-trapping materials, the silicon compound can be removed from the gaseous matter passing through the silicon trapping body 3.

It is preferred that the silicon trapping body 3 contains activated carbon as the silicon-trapping material. In this case, the capability of removing the silicon compound by the presence of the silicon trapping body 3 can be improved.

It is preferred that the silicon trapping body 3 comprises an inorganic porous body which contains the silicon-trapping material. In this case, not only can the circulation of the gas in the silicon trapping body 3 be secured, but also the capability of removing the silicon compound can be exerted.

It is preferred that the inorganic porous body is a silica particle sintered body (i.e. a silica particle sintered porous body). In this case, the capability of removing the silicon compound by the presence of the silicon trapping body 3 can be further improved due to the high affinity of the silica particle for the silicon compound.

It is preferred that a pore diameter of the silica particle is in the range of 3 to 30 nm. In this case, the capability of removing the silicon compound by the presence of the silicon trapping body 3 is further improved.

It is preferred that the silicon trapping body 3 comprises a first body and a second body that are silica particle sintered bodies containing platinum. The second body is laminated on the outside of the first body. The second body also has a higher platinum content than the first body. In this case, because second body has a higher platinum content, the silicon trapping body 3 has sufficient silicon trap performance. Further, the first body with low platinum content can inhibit electrical conduction between the sensing part 2 and the silicon trapping body 3 to inhibit the degradation of detection sensitivity caused by the electrical conduction.

It is preferred that the silicon trapping body 3 is in direct contact with the sensing part 2. In this case, the gas passing through the silicon trapping body 3 can reach the sensing part 2 without being blocked. As a result, the target gas can reach the sensing part 2 easily, and high detection sensitivity can be expected.

In the case that the silicon trapping body 3 is in direct contact with the sensing part 2, when the silicon trapping body 3 is a silica particle sintered body containing platinum, it is preferred that the hydrogen gas sensor have a measuring circuit for applying voltage to the sensing part 2 to set a preset temperature of the sensing part 2 in the range of 110 to 350° C. In this case, not only can good hydrogen detection sensitivity be obtained by the sensing part 2, but also an increase in temperature of the silicon trapping body 3 can be inhibited and a decrease in hydrogen gas sensitivity caused by an increase in temperature of the silicon trapping body 3 can also be inhibited. Therefore, the silicon compound-tolerance of the detection element 1 can be maintained over a long period of time.

Also, In the case that the silicon trapping body 3 is in direct contact with the sensing part 2, when the silicon trapping body 3 contains activated carbon as the silicon-trapping material, it is preferred that the hydrogen gas sensor have a measuring circuit for applying voltage to the sensing part to set the preset temperature of the sensing part 2 in the range of 110 to 200° C. In this case, not only can good hydrogen detection sensitivity be obtained by the sensing part 2, but also an increase in temperature of the silicon trapping body 3 can be inhibited and a decrease in hydrogen gas sensitivity caused by an increase in temperature of the silicon trapping body 3 can also be inhibited. Therefore, the silicon compound-tolerance can be maintained over a long period of time.

It is preferred that a heat insulating body 6 is interposed between the silicon trapping body 3 and the sensing part 2. In this case, heat transmission from the sensing part 2 to the silicon trapping body 3 can be blocked by the heat insulating body 6, which cause that an increase in temperature of the silicon trapping body 3 is inhibited. Therefore, deterioration of a silicon trap function due to a change in properties of the silicon-trapping material can be inhibited, and a decrease in detection sensitivity can be inhibited.

In the case of providing the heat insulating body 6 as described above, it is preferred that the heat insulating body 6 is formed by an inorganic porous body. In this case, the heat insulating body 6 can be provided with a high heat insulation performance.

Also, in the case of providing the heat insulating body 6 as described above, when the silicon trapping body 3 is the silica particle sintered body containing platinum, it is preferred that the hydrogen gas sensor have a measuring circuit for applying voltage to the sensing part to set the preset temperature of the sensing part 2 in the range of 110 to 400° C. In this case, not only can good hydrogen detection sensitivity be obtained by the sensing part 2, but also an increase in temperature of the silicon trapping body 3 can be inhibited and a decrease in hydrogen gas sensitivity caused by an increase in temperature of the silicon trapping body 3 can also be inhibited. Therefore, the silicon compound-tolerance can be maintained over a long period of time.

Also, in the case of bringing the silicon trapping body 3 into contact with the surface of the sensing part 2, when the silicon trapping body 3 contains activated carbon as the silicon-trapping material, it is preferred that the hydrogen gas sensor have a measuring circuit for applying voltage to the sensing part to set the preset temperature of the sensing part 2 in the range of 110 to 250° C. In this case, not only can good hydrogen detection sensitivity be obtained by the sensing part 2, but also an increase in temperature of the silicon trapping body 3 can be inhibited and a decrease in hydrogen gas sensitivity caused by an increase in temperature of the silicon trapping body 3 can also be inhibited. Therefore, the silicon compound-tolerance can be maintained over a long period of time.

### BRIEF DESCRIPTION OF THE DRAWINGS

FIG. 1 A first embodiment of the present invention is shown, wherein (a) and (b) are cross-sectional diagrams.

FIG. 2 A second embodiment of the present invention is shown, wherein (a) to (c) are cross-sectional diagrams.

FIG. 3 A front view of a part of a hydrogen gas sensor according to the first and second embodiments of the present invention.

FIG. 4 An external perspective view of the hydrogen gas sensor according to the first and second embodiments of the present invention.

FIG. 5 A cross-sectional diagram of the hydrogen gas sensor according to the first and second embodiments of the present invention.

FIG. 6 A front view of a part of a hydrogen gas sensor according to a third embodiment of the present invention.

FIG. 7 A circuit diagram of a measuring circuit including the hydrogen gas sensor.

FIG. 8 An external perspective view of a part of a conventional catalytic combustion type gas sensor.

FIG. 9 A graph showing the results of measurements of hydrogen concentration dependence of detection sensitivity of the hydrogen gas sensor performed in Examples 1 to 7 and Comparative Example 1.

FIG. 10 A graph showing the results of measurements of hydrogen concentration dependence of the detection sensitivity of the hydrogen gas sensor performed in Examples 8 to 10 and Comparative Example 1.

FIG. 11 A graph showing the results of measurements of changes in the detection sensitivity of the hydrogen sensor poisoned by silicon compound, the measurements being performed in Examples 1 to 5 and 7 and Comparative Example 1.

FIG. 12 A graph showing the results of measurements of changes in the detection sensitivity of the hydrogen sensor poisoned by the silicon compound, the measurements being performed in Examples 8 to 10 and Comparative Example 1.

FIG. 13 A graph showing the results of measurements of changes in the detection sensitivity of the hydrogen sensor when operating voltage is changed, the measurements being performed in Examples 8 to 10.

FIG. 14 A graph showing the results of measurements of changes in the detection sensitivity of the hydrogen sensor poisoned by the silicon compound when the operating voltage is changed, the measurements being performed in Example 1.

FIG. 15 A graph showing the results of measurements of changes in the detection sensitivity of the hydrogen sensor poisoned by the silicon compound when the operating voltage is changed, the measurements being performed in Example 6.

FIG. 16 A graph showing the results of measurements of changes in the detection sensitivity of the hydrogen sensor poisoned by the silicon compound when the operating voltage is changed, the measurements being performed in Example 8.

FIG. 17 A graph showing the results of measurements of changes in the detection sensitivity of the hydrogen sensor poisoned by the silicon compound when the operating voltage is changed, the measurements being performed in Example 9.

FIG. 18 A graph showing the results of measurements of changes in the detection sensitivity of the hydrogen sensor poisoned by the silicon compound when the operating voltage is changed, the measurements being performed in Example 10.

### BEST MODE FOR CARRYING OUT THE INVENTION

The present invention is described in detail with reference to the accompanying drawings.

### First Embodiment

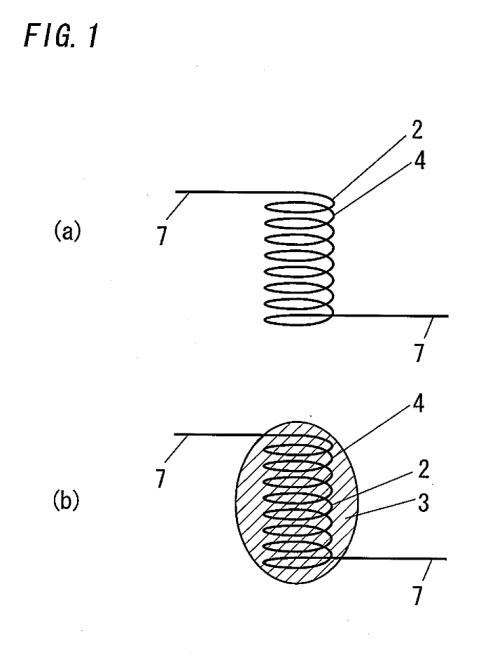

The first embodiment according to the present invention is described with reference to FIG. 1.

A detection element 1 of this hydrogen gas sensor has a sensing part 2 and a silicon trapping body 3.

The sensing part 2 has a function of being heated by Joule heat generated by energization of the sensing part 2, a function of combusting hydrogen gas while being heated, and a function of outputting a change in electrical resistance of the sensing part 2 indicative of hydrogen gas concentration, the change in electrical resistance being caused by an increase in temperature of the sensing part 2 caused by the combustion heat of the hydrogen gas.

In the present embodiment, the sensing part 2 is configured by a heating resistor 4 only. Therefore, the heating resistor 4 of the present embodiment has the function of being heated by Joule heat generated by the energization, and the function of outputting a change in electrical resistance of the sensing part 2 indicative of the hydrogen gas concentration, the change in electrical resistance being caused by an increase in temperature of the sensing part 2 caused by the combustion heat of the hydrogen gas.

This heating resistor 4 can be formed by a metal having catalytic activity, such as platinum, zirconia stabilized platinum or other platinum alloy.

In the embodiment shown in FIG. 1(a), a metal wire having catalytic activity is coiled up to form the heating resistor 4. In this case, the wire diameter of the metal wire can be in the range of 10 to 50 μm and the number of turns of the coiled metal wire can be between 5 and 30. Note that the work of coiling up the heating resistor 4 may be omitted by forming the heating resistor 4 into a straight line. Terminal parts 7 composed of metal wires are stretched out from both ends of the heating resistor 4 respectively.

The surface of the heating resistor 4 needs to have a hydrogen combustion catalytic activity. If the catalytic activity is insufficient, it is preferred that a process for improvement of the catalytic activity be performed. For example, an activation solution selected from among an aqueous chloroplatinic solution, a palladium nitrate solution and the like is applied to the surface of the heating resistor 4 and this surface is burned at approximately 800° C., which can cause the catalytic activity of the surface of the heating resistor 4 improved.

The silicon trapping body 3 is formed to cover the sensing part 2, as shown in FIG. 1(b). The silicon trapping body 3 has a function of trapping and removing a silicon compound from gaseous matter (target gas) passing through the silicon trapping body 3.

The silicon trapping body 3 is preferably formed into a porous body so that the target gas can pass therethrough. The silicon trapping body 3 contains a material functioning to trap the silicon compound (referred to as “silicon-trapping material” hereinafter). Examples of the silicon-trapping material include platinum, activated carbon, and the like. These silicon-trapping materials are preferably dispersed in the silicon trapping body 3. The silicon trapping body 3 is formed to cover the entire sensing part 2 in contact with a surface of the sensing part 2.

Specific examples of such a silicon trapping body 3 can include (1) the silicon trapping body 3 configured by an inorganic porous body containing platinum, (2) the silicon trapping body 3 that is configured by a body formed of activated carbon, and (3) the silicon trapping body 3 configured by a body of activated carbon containing platinum. Specific methods for forming these bodies 3 for trapping silicon are described hereinafter.

(1) Silicon Trapping Body Configured by an Inorganic Porous Body Containing Platinum

One of the examples of the method for forming the silicon trapping body 3 is as follows. A mixture of an alumina sol or a sol of inorganic oxide particles such as colloidal silica and a chloroplatinic acid mixture are prepared. This mixture is applied to the periphery of the sensing part 2 to cover the entire sensing part 2, which is then burned at, preferably, 300 to 500° C. As a result, the silicon trapping body 3 constructed by the inorganic porous body containing platinum is formed.

Another one of the examples of forming the silicon trapping body 3 is as follows. Platinum is carried in inorganic oxide particles such as alumina (γ alumina or the like) and silica. In so doing, for example, a chloroplatinic solution is added to the particles such as alumina and silica, which is heated to remove the moisture thereof and thereafter heated at 300 to 500° C. so that the platinum can be carried in the inorganic oxide particles. Next, the inorganic oxide particles carrying platinum is mixed with water and a binder to prepare a paste-like mixture. This mixture is applied to the periphery of the sensing part 2 to cover the entire sensing part 2, and then burned at, preferably, 300 to 500° C. As a result, the silicon trapping body 3 composed of the inorganic porous body with platinum can be formed.

As the inorganic oxide particles, it is preferred that silica particles with a high affinity for, particularly, the silicon compound be used. It is preferred that the particle size of each silica particle be in the range of 0.5 to 5 μm. Accordingly, excellent formability of the silicon trapping body 3 composed of the inorganic porous body can be realized. Furthermore, the silica particles are preferably porous particles. In this case, the specific surface area of the silica particles (BET specific surface area measured by means of a gas absorption method) is preferably in the range of 200 to 800 m²/g. Accordingly, a large amount of silicon-trapping material can be carried in the silicon trapping body 3 in a good dispersed state. Moreover, it is desired that the pore diameter of the silicon particle (the average pore diameter measured by means of the gas absorption method) be in the range of 3 to 30 nm. Accordingly, the silicon trap capability of the silicon trapping body 3 can be enhanced.

Alumina sol, silica sol, or other sol of inorganic oxide particles can be used as the binder. The binder loadings are adjusted appropriately such that the paste-like mixture can be applied to the sensing part 2 and that the configuration of the silicon trapping body 3 obtained by sintering this mixture can be kept. However, excessive binder loadings might close the pores of the silicon trapping body 3, making it impossible to maintain the porous structure. Hence, it is preferred that the binder be added in a minimum necessary amount.

The platinum content in each of these bodies 3 for trapping silicon can be controlled by adjusting the amount of the chloroplatinic acid used. The platinum content in each silicon trapping body 3 is preferably in the range of 5 to 30 wt %. Accordingly, the bodies 3 for trapping silicon can be provided with a sufficient silicon trap capability and the detection element 1 can be provided with sufficient the silicon compound-tolerance. A platinum content of less than 5 wt % might not be able to provide the silicon trapping body 3 with a sufficient silicon trap capability. Also, a platinum content of more than 30 wt % might cause electrical conduction between the sensing part 2 and the silicon trapping body 3, resulting in the degradation of the detection sensitivity.

The outer diameter dimension of the silicon trapping body 3 is preferably in the range of 0.3 to 1 mm. Accordingly, the silicon trapping body 3 can be provided with a sufficient silicon trap performance and the hydrogen gas sensor can exert the responsive capability thereof. If the dimension of the silicon trapping body 3 is too small, there is a possibility that its capability of trapping/removing the silicon compound cannot be obtained sufficiently, but if the dimension of the silicon trapping body 3 is too large, it is difficult to control the dimension of the detection element 1 during the production process, and the mechanical strength of the detection element 1 and the responsive capability might be degraded.

Furthermore, this silicon trapping body 3 may be configured by a first body that is a silica particle sintered body containing platinum and a second body that is a silica particle sintered body. The second body is provided outside the first body and contains more platinum than the first body. Accordingly, the second body with high platinum content can provide the silicon trapping body 3 with a sufficient silicon trap performance. The platinum content of the second body can be 45 wt % at a maximum. Moreover, the first body with low platinum content can inhibit the occurrence of electrical conductivity between the sensing part 2 and the silicon trapping body 3, as well as the degradation of the detection sensitivity caused by the electrical conductivity.

The dimensions of the first body and second body are set appropriately. The first body may have a dimension to cover the entire sensing part 2. The larger the dimension of the second body in relation to the first body, the higher the silicon trap performance can be provided to the silicon trapping body 3. For example, the dimension of the outer diameter of the first body is set at 0.3 mm and the dimension of the outer diameter of the entire silicon trapping body 3 is set at 1 mm. In this case, the second body becomes to be formed to have a larger dimension, and the silicon trapping body 3 can be provided with a high silicon trap performance.

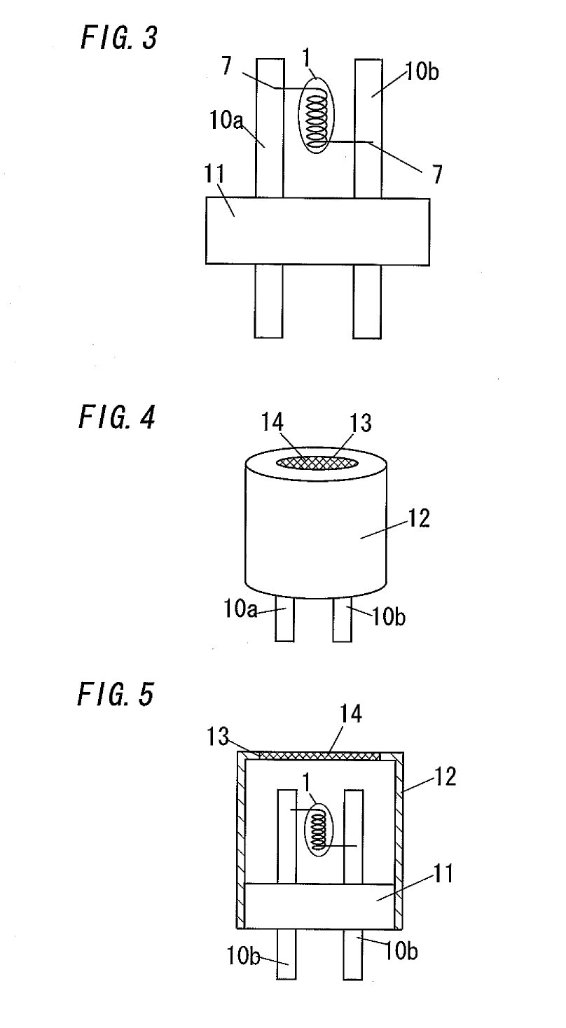

In addition to the detection element 1, the hydrogen gas sensor further has stems 10a, 10b, a base 11, and a protective cap 12, as shown in FIGS. 3 to 5.

The base 11 is formed into a disk by synthetic resin. The two stems 10a, 10b are inserted-molded into the base 11 so as to penetrate the base 11 in a vertical direction. Terminal parts 7, 7 that are stretched out from both ends of the sensing part 2 are fixed to the two stems 10a, 10b respectively. The terminal parts 7, 7 fixed, by means of a welding method or the like, to the sections of the stems 10a, 10b that project from the upper surface of the base 11.

The protective cap 12 has a substantially cylindrical shape wherein an opened end part on the lower surface side. The protective cap 12 may be made of metal or resin. The base 11 is inserted and fixed to the opening part of the protective cap 12, and the detection element 1 is stored in the protective cap 12. A round through-hole 13 is penetrated through the center of the upper surface of the protective cap 12. A stainless wire net 14 of 100 mesh is formed in a tension state in the through-hole 13 for explosion protection.

The stems 10a, 10b are connected to a measuring circuit. The measuring circuit applies a substantially constant voltage between the stems 10a, 10b and measures the value of current flowing between the stems 10a, 10b.

In the hydrogen gas sensor with the configuration described above, the measuring circuit applies a substantially constant voltage between the stems 10a, 10b when the hydrogen gas is measured. Consequently, the sensing part 2 is heated to a predetermined temperature. The predetermined temperature is appropriately set at a temperature at which the hydrogen is combusted on the surface of the heating resistor 4 configuring the sensing part 2.

However, when this temperature is too high, the temperature of the silicon trapping body 3 is increased by the heat transmitted from the sensing part 2, leading to a negative impact. In other words, increased temperature of the silicon trapping body 3 induces aggregation of the platinum in the silicon trapping body 3, whereby the function of the silicon trapping body 3 for trapping the silicon compound is degraded, and the sensing part 2 is poisoned by the silicon compound, degrading the hydrogen gas sensitivity.

For this reason, the voltage (operating voltage) applied by the measuring circuit to the sensing part 2 is preferably set in the range in which a sufficient hydrogen sensitivity can be obtained by the sensing part 2 without causing the degradation of the hydrogen gas sensitivity caused by an increase in temperature of the silicon trapping body 3. Specifically, the measuring circuit applies the voltage to the sensing part 2 on the condition that the temperature (preset temperature) of the sensing part 2 is in the range of 110 to 350° C.

The condition that the preset temperature of the sensing part 2 is in the range of 110 to 350° C. means that the temperature of the sensing part 2 is in the range of 110 to 350° C. when the voltage is applied to the sensing part 2 alone, namely, the sensing part 2 not covered with the silicon trapping body 3, under an inert atmosphere at 20° C. Therefore, the preset temperature of the sensing part 2 is different from the actual temperature of the sensing part 2 obtained when the hydrogen gas sensor is actually used.

The voltage that is applied under the condition that the preset temperature of the sensing part 2 is in the range of 110 to 350° C. can be obtained beforehand by an actual measurement. An example of the method of deriving this applied voltage is described below.

Voltage is applied to the sensing part 2 under an inert atmosphere at 20° C., and a change in current energizing the sensing part 2 is measured in relation to a change in the voltage applied to the sensing part 2. An electrical resistance value of the sensing part 2 is derived based on the applied voltage and the current. Consequently, a change in the electrical resistance value of the sensing part 2 in relation to the change in the applied voltage is derived.

Since the electrical resistance value of the sensing part 2 changes depending on the temperature of the sensing part 2, the temperature of the sensing part 2 is derived from the electrical resistance value of the sensing part 2. Specifically, when an electrical resistance value Rₜ of the sensing part 2 at t ° C. is already known, an electrical resistance value R_{T} of the sensing part 2 at T ° C. is derived from an equation, R_{T}=Rₜ×{1+C×(T−t)}. C in this equation is a resistance temperature coefficient of the sensing part 2.

Consequently, a change in the temperature of the sensing part 2 in relation to a change in the applied voltage can be derived based on a change in the electrical resistance value of the sensing part 2 in relation to the change in the applied voltage. Derived next is the value of the applied voltage in the case where the temperature of the sensing part 2 is a desired temperature in the range of 110 to 350° C. This applied voltage derived as above is obtained as the operating voltage to be applied to the sensing part 2 by the measuring circuit.

In such a state in which the voltage is applied to the sensing part 2, the target gas is introduced from the through-hole 13 of the protective cap 12 into the protective cap 12. This target gas reaches the sensing part 2 through the silicon trapping body 3.

When the target gas contains vapor of the silicon compound, this silicon compound is trapped and removed by the silicon trapping body 3 so that the sensing part 2 is prevented from being poisoned by the silicon compound.

Also, when the target gas contains hydrogen gas, this hydrogen gas reaches the sensing part 2 through the silicon trapping body 3 and combusted on the surface of the sensing part 2 due to a catalytic action of the platinum on the surface of the sensing part 2. Although the platinum is present in the silicon trapping body 3, hydrogen combustion does not occur in the silicon trapping body 3 because an increase in temperature of the silicon trapping body 3 is inhibited when the preset temperature of the sensing part 2 is in the range of 110 to 350° C.

This hydrogen combustion on the surface of the sensing part 2 leads to an increase in the temperature of the sensing part 2 due to the resulting combustion heat and thereby an increase in the electrical resistance of the sensing part 2 in accordance with the temperature increase. The measuring circuit not only measures the amount of change in the electrical resistance of the sensing part 2 but also derives the concentration of the hydrogen gas based on the amount of change in the electrical resistance.

In the present embodiment, the temperature of the heating resistor 4 needs to be set at a temperature that does not cause an increase in temperature of the silicon trapping body 3 that is in direct contact with the heating resistor 4. However, since the heat insulating body 6 of the after-mentioned second embodiment is not provided, the target gas can reach the sensing part 2 without being blocked by the heat insulating body 6. Therefore, the target gas can reach the sensing part 2 easily, and high detection sensitivity can be expected.

(2) Silicon Trapping Body that is Configured by a Body Formed of Activated Carbon

Fine granular activated carbon is mixed with water and a binder to prepare a paste-like mixture. This mixture is applied to the periphery of the sensing part 2 to cover the entire sensing part 2, and then burned at, preferably, 200 to 300° C. As a result, the silicon trapping body 3 that is configured by a body formed of activated carbon can be formed.

Crushed fine particles that are obtained by grinding granular activated carbon having a specific surface area of, for example, approximately 1000 m² in a mortar can be used as the fine granular activated carbon. Also, an alumina sol or a sol of inorganic oxide particles such as colloidal silica can be used as the binder. The binder loadings are adjusted appropriately such that the paste-like mixture can be applied to the sensing part 2 and that the configuration of the silicon trapping body 3 obtained by sintering this mixture can be kept. However, excessive binder loadings might close the pores of the activated carbon contained in the silicon trapping body 3 and reduce the surface area of the activated carbon, resulting in the degradation of the capability of the silicon trapping body 3 to trap the silicon compound. Hence, it is preferred that the binder be added in a minimum necessary amount.

The outer diameter dimension of the silicon trapping body 3 is preferably in the range of 0.3 to 1 mm. Accordingly, the silicon trapping body 3 can be provided with a sufficient silicon trap performance and the hydrogen gas sensor can exert the responsive capability thereof. If the dimension of the silicon trapping body 3 is too small, there is a possibility that its capability of trapping/removing the silicon compound cannot be obtained sufficiently, but if the dimension of the silicon trapping body 3 is too large, it is difficult to control the dimension of the detection element 1 during the production process, and the mechanical strength of the detection element 1 and the responsive capability might be degraded.

In addition to the detection element 1 configured as above, the hydrogen gas sensor is further provided with the stems 10a, 10b, the base 11, and the protective cap 12 as described above and shown in FIGS. 3 to 5, wherein the hydrogen gas sensor is configured by connecting the measuring circuit to the stems 10a, 10b. When measuring the hydrogen gas, the measuring circuit applies voltage to the heating resistor 4 such that the temperature of the sensing part 2 falls within the range that does not reduce the hydrogen gas sensitivity.

However, when this temperature is too high, the temperature of the silicon trapping body 3 is increased by the heat transmitted from the sensing part 2, leading to a negative impact. In other words, increased temperature of the silicon trapping body 3 alters the activated carbon contained in the silicon trapping body 3, whereby the function of the silicon trapping body 3 for trapping the silicon compound is degraded, and the sensing part 2 is poisoned by the silicon compound, degrading the hydrogen gas sensitivity.

For this reason, the voltage (operating voltage) applied by the measuring circuit to the sensing part 2 is preferably set in the range in which a sufficient hydrogen sensitivity can be obtained by the sensing part 2 without causing the degradation of the hydrogen gas sensitivity caused by an increase in temperature of the silicon trapping body 3. Specifically, the measuring circuit applies the voltage to the sensing part 2 on the condition that the temperature (preset temperature) of the sensing part 2 is in the range of 110 to 200° C.

The condition that the preset temperature of the sensing part 2 is in the range of 110 to 200° C. means that the temperature of the sensing part 2 is in the range of 110 to 200° C. when the voltage is applied to the sensing part 2 alone, namely, the sensing part 2 not covered with the silicon trapping body 3, under an inert atmosphere at 20° C. Therefore, the preset temperature of the sensing part 2 is different from the actual temperature of the sensing part 2 obtained when the hydrogen gas sensor is actually used.

(3) Silicon Trapping Body Configured by a Body of Activated Carbon Containing Platinum

Fine granular activated carbon is caused to carry platinum. In this case, the fine granular activated carbon is immersed in an aqueous chloroplatinic solution, which is let stand. The aqueous chloroplatinic solution, with the fine granular activated carbon immersed therein, is filtered and separated from the fine granular activated carbon, and the separated fine granular activated carbon is heated at, preferably, 200 to 300° C. to obtain the fine granular activated carbon carrying platinum.

This fine granular activated carbon carrying platinum is mixed with water and a binder to prepare a paste-like mixture. This mixture is applied to the periphery of the sensing part 2 to cover the entire sensing part 2, and then burned at, preferably, 200 to 300° C. As a result, the silicon trapping body 3 configured by a body of activated carbon containing platinum can be formed.

The platinum content in this silicon trapping body 3 can be controlled by adjusting the amount of the chloroplatinic acid used. The greater the platinum content within the silicon trapping body 3, the higher the capability of trapping/removing the silicon compound by the presence of the silicon trapping body 3, but this content is set in the range of, preferably, 5 to 30 wt %.

Crushed fine particles that are obtained by grinding granular activated carbon having a specific surface area of, for example, approximately 1000 m² in a mortar can be used as the fine granular activated carbon. Also, an alumina sol or a sol of inorganic oxide particles such as colloidal silica can be used as the binder. The binder loadings are adjusted appropriately such that the paste-like mixture can be applied to the sensing part 2 and that the configuration of the silicon trapping body 3 obtained by sintering this mixture can be kept. However, excessive binder loadings might close the pores of the activated carbon contained in the silicon trapping body 3 and reduce the surface area of the activated carbon, resulting in the degradation of the capability of the silicon trapping body 3 to trap the silicon compound. Hence, it is preferred that the binder be added in a minimum necessary amount.

The outer diameter dimension of the silicon trapping body 3 is preferably in the range of 0.3 to 1 mm. In this range, the silicon trapping body 3 can be provided with a sufficient silicon trap performance and the hydrogen gas sensor can exert the responsive capability thereof. If the dimension of the silicon trapping body 3 is too small, there is a possibility that its capability of trapping/removing the silicon compound cannot be obtained sufficiently, but if the dimension of the silicon trapping body 3 is too large, it is difficult to control the dimension of the detection element 1 during the production process, and the mechanical strength of the detection element 1 and the responsive capability might be degraded.

In addition to the detection element 1 configured as above, the hydrogen gas sensor is further provided with the stems 10a, 10b, the base 11, and the protective cap 12 as described above and shown in FIGS. 3 to 5, wherein the hydrogen gas sensor is configured by connecting the measuring circuit to the stems 10a, 10b. When measuring the hydrogen gas, the measuring circuit applies voltage to the heating resistor 4 such that the temperature of the sensing part 2 falls within the range that does not reduce the hydrogen gas sensitivity.

However, when this temperature is too high, the temperature of the silicon trapping body 3 is increased by the heat transmitted from the sensing part 2, leading to a negative impact. In other words, increased temperature of the silicon trapping body 3 alters the activated carbon contained in the silicon trapping body 3, whereby the function of the silicon trapping body 3 for trapping the silicon compound is degraded, and the sensing part 2 is poisoned by the silicon compound, degrading the hydrogen gas sensitivity.

For this reason, the voltage (operating voltage) applied by the measuring circuit to the sensing part 2 is preferably set in the range in which a sufficient hydrogen sensitivity can be obtained by the sensing part 2 without causing the degradation of the hydrogen gas sensitivity caused by an increase in temperature of the silicon trapping body 3. Specifically, the measuring circuit applies the voltage to the sensing part 2 on the condition that the temperature (preset temperature) of the sensing part 2 is in the range of 110 to 200° C.

The condition that the preset temperature of the sensing part 2 is in the range of 110 to 200° C. means that the temperature of the sensing part 2 is in the range of 110 to 200° C. when the voltage is applied to the sensing part 2 alone, namely, the sensing part 2 not covered with the silicon trapping body 3, under an inert atmosphere at 20° C. Therefore, the preset temperature of the sensing part 2 is different from the actual temperature of the sensing part 2 obtained when the hydrogen gas sensor is actually used.

In the present embodiment, the temperature of the heating resistor 4 needs to be set at a temperature that does not cause an increase in temperature of the silicon trapping body 3 that is in direct contact with the heating resistor 4. However, since the heat insulating body 6 of the after-mentioned second embodiment is not provided, the target gas can reach the sensing part 2 without being blocked by the heat insulating body 6. Therefore, the target gas can reach the sensing part 2 easily, and high detection sensitivity can be expected.

### Second Embodiment

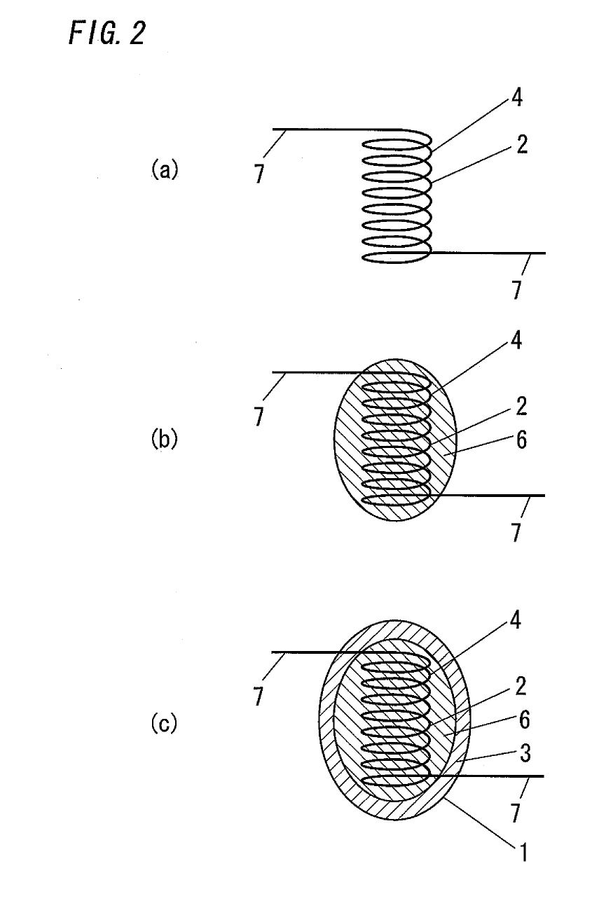

A second embodiment according to the present invention is described with reference to FIG. 2.

A detection element 1 of this hydrogen gas sensor has a sensing part 2, a heat insulating body 6 and a silicon trapping body 3.

The sensing part 2 with the same functions and the same structure as that in the first embodiment can be formed by the same method as in the first embodiment, as shown in FIG. 2(a).

The heat insulating body 6 is formed so as to cover the entire sensing part 2 and to come into contact with the surface of the sensing part 2 as shown in FIG. 2(b). This heat insulating body 6 is interposed between the sensing part 2 and the silicon trapping body 3. The heat insulating body 6 has a function of allowing a gaseous matter that has passed through the silicon trapping body 3 to reach the sensing part 2, and a function of inhibiting the movement of heat between the sensing part 2 and the silicon trapping body 3.

The heat insulating body 6 can be formed by an inorganic porous body composed of alumina (γ-alumina or the like), silica and the like.

One of the examples of the method for forming the heat insulating body 6 is as follows. Fine organic particles are mixed into an alumina sol or a sol of inorganic oxide particles such as colloidal silica, if necessary. This sol is applied to the periphery of the sensing part 2 to cover the entire sensing part 2, which is then burned at, preferably, 300 to 400° C. As a result, the heat insulating body 6 can be formed.

The fine organic particles are used, if necessary, in order to adjust the porosity of the heat insulating body 6. Particles that are carbonized and dissolved during the burning process performed in the formation of the heat insulating body 6 are used as the fine organic particles. Specifically, particles made of acetylcellulose or the like can be used. The diameter of each of the fine organic particles and the amount thereof used are appropriately set in accordance with the porosity required for the heat insulating body 6, and by using the particles with a diameter of, for example, approximately 1 μm and appropriately adjusting the mixing ratio of the fine organic particles, the porosity of the heat insulating body 6 can be set at approximately 10 to 50%.

Another one of the examples of forming the heat insulating body 6 is as follows. Water and a binder are mixed with inorganic oxide particles such as alumina (γ alumina or the like) and silica, and further fine organic particles are mixed therewith, if necessary, to prepare a paste-like mixture. This mixture is applied to the periphery of the sensing part 2 to cover the entire sensing part 2, which is then burned at, preferably, 300 to 400° C. As a result, the heat insulating body 6 can be formed.

Alumina sol, silica sol, or other sol of inorganic oxide particles can be used as the binder. The binder loadings are adjusted appropriately such that the paste-like mixture can be applied to the sensing part 2 and that the configuration of the heat insulating body 6 obtained by sintering this mixture can be kept. However, excessive binder loadings might close the pores of the heat insulating body 6, making it impossible to maintain the porous structure. Hence, it is preferred that the binder be added in a minimum necessary amount.

The fine organic particles in this case are also used, if necessary, in order to adjust the porosity of the heat insulating body 6, and the same particles as above are used. The diameter of each of the fine organic particles and the amount thereof used are appropriately set in accordance with the porosity required for the heat insulating body 6.

The porosity and dimension of this heat insulating body 6 are determined within a range in which the movement of the heat between the sensing part 2 and the silicon trapping body 3 can be sufficiently inhibited. A sufficient heat insulating operation can be exerted by setting the porosity of the heat insulating body 6 in the range of, for example 10 to 50% and the outer diameter dimension of the same in the range of 0.2 to 0.3 mm.

The silicon trapping body 3 is formed so as to cover the entire sensing part 2 composed only of the heating resistor 4 and to come into contact with the surface of the sensing part 2 in the first embodiment as shown in FIG. 1(b), while it is formed so as to cover the entire heat insulating body 6 and to come into contact with the surface of the heat insulating body 6 in the second embodiment as shown in FIG. 2(c). Therefore, the heat insulating body 6 is interposed between the sensing part 2 and the silicon trapping body 3. Except for this difference, the silicon trapping body 3 of the second embodiment has the same functions and the same structure as the silicon trapping body 3 of the first embodiment and hence can be formed by the same method as in the first embodiment. The dimension of the silicon trapping body 3 in this case is preferably set such that the sum of the outer diameter dimensions of the heat insulating body 6 and the silicon trapping body 3 is in the range of 0.3 to 0.7 mm. The greater the dimension of the silicon trapping body 3, the higher the capability of trapping/removing the silicon compound by the presence of the silicon trapping body 3.

In addition to the detection element 1 configured as described above, the hydrogen gas sensor according to the present embodiment has the stems 10a, 10b, the base 11, and the protective cap 12 as shown in FIGS. 3 to 5 and as with the hydrogen gas sensor of the first embodiment, wherein the measuring circuit is connected between the stems 10a, 10b. When measuring the hydrogen gas, the measuring circuit applies voltage to the heating resistor 4 such that the temperature of the sensing part 2 falls within the range that does not reduce the hydrogen gas sensitivity. When this temperature is too high, the temperature of the silicon trapping body 3 is increased by the heat transmitted from the sensing part 2, leading to a negative impact.

In the present embodiment, however, an increase in temperature of the silicon trapping body 3 is inhibited by the heat insulating body 6 that inhibits the transmission of the heat from the heating resistor 4 to the silicon trapping body 3. Therefore, in the present embodiment even when the temperature of the sensing part 2 is higher as compared with the first embodiment, decrease in hydrogen gas sensitivity caused by an increase in temperature of the silicon trapping body 3 can also be inhibited.

More specifically, when the silicon trapping body 3 is a silica particle sintered body containing platinum, it is preferred that the measuring circuit apply voltage to the sensing part 2 on the condition that the temperature (preset temperature) of the sensing part 2 is in the range of 110 to 400° C. Also, when the silicon trapping body 3 contains activated carbon as the silicon-trapping material, it is preferred that the measuring circuit apply voltage to the sensing part 2 on the condition that the temperature (preset temperature) of the sensing part is in the range of 110 to 250° C.

The conditions that the preset temperature of the sensing part 2 is in the range of 110 to 400° C. and in the range of 110 to 250° C. mean that the temperature of the sensing part 2 falls within these ranges when the voltage is applied to the sensing part 2 alone, namely, the sensing part 2 not covered with the silicon trapping body 3, under an inert atmosphere at 20° C. Therefore, the preset temperature of the sensing part 2 is different from the actual temperature of the sensing part 2 obtained when the hydrogen gas sensor is actually used.

In this state, the target gas is introduced from the through-hole 13 of the protective cap 12 into the protective cap 12. This target gas reaches the sensing part 2 through the silicon trapping body 3 and the heat insulating body 6. At this moment, when the target gas contains vapor of the silicon compound, this silicon compound is trapped and removed by the silicon trapping body 3 so that the sensing part 2 is prevented from being poisoned by the silicon compound. Consequently, the degradation of the detection sensitivity due to poisoning of the sensing part 2 with the silicon compound can be inhibited.

Also, when the target gas contains hydrogen gas, this hydrogen gas reaches the heating resistor 4 and combusted due to a catalytic action on the surface of the heating resistor 4. At this moment, the temperature of the heating resistor 4 is increased by the heat generated from the combustion of the hydrogen gas. The electrical resistance of the heating resistor 4 increases in response to this temperature increase. The measuring circuit not only measures the amount of change in the electrical resistance of the heating resistor 4 but also derives the concentration of the hydrogen gas based on the amount of change in the electrical resistance.

Since the heat insulating body 6 is formed in the present embodiment as described above, the passage of the target gas is blocked by the heat insulating body 6, but the temperature of the sensing part 2 can be increased. Therefore, the hydrogen combustion efficiency within the sensing part 2 can be improved when increasing the temperature of the sensing part 2, and high detection sensitivity can be expected.

### Third Embodiment

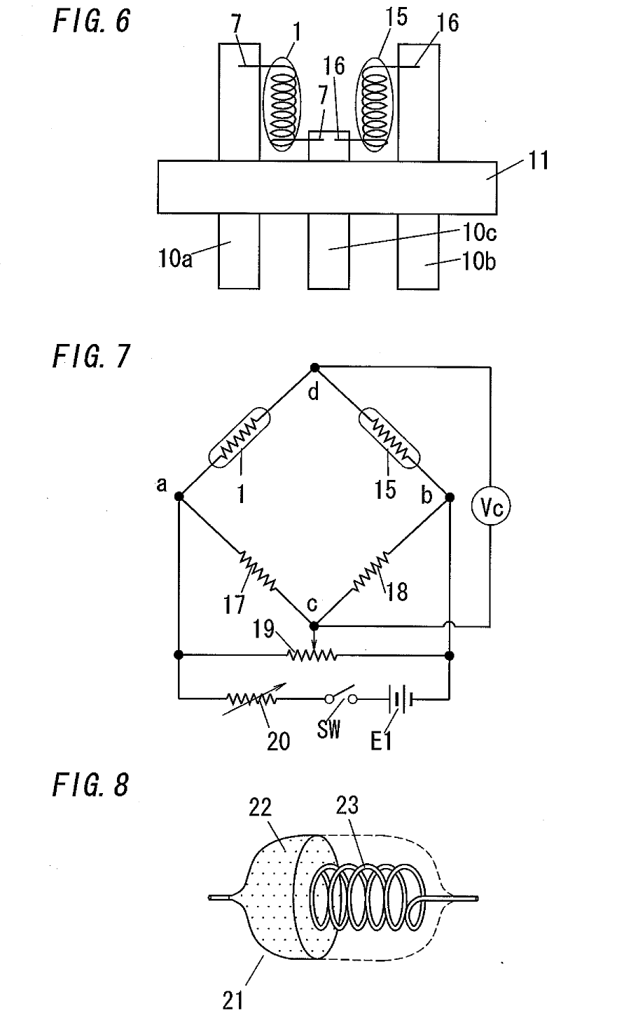

In each of the above embodiments the hydrogen gas sensor can be provided with a compensation element 15 in addition to the detection element 1. As shown in FIG. 6, in the present embodiment the compensation element 15 is provided in the configurations of the first and second embodiments where the bead-shaped detection element 1 is provided.

The compensation element 15 has the same structure as the detection element 1 provided in the hydrogen gas sensor, except that the compensation element 15 has a non-sensing part instead of the sensing part 2, the non-sensing part having the same structure as the sensing part 2 except for the function of combusting the hydrogen gas while being heated (specifically, except for a hydrogen combustion catalytic activity).

Specifically, in the case of the first embodiment or the second embodiment, the heating resistor 4 of each embodiment is subjected to the processing for elimination of the hydrogen combustion catalytic activity. The processing for reduction of the hydrogen combustion catalytic activity of platinum is performed by, for example, poisoning, beforehand, the surface of the heating resistor 4 configured by a platinum wire or the like by means of silicon compound vapor or applying an appropriate amount of chloroauric acid solution to the surface of the heating resistor 4 to alloy the platinum of the surface of the heating resistor 4 with a gold. Except for this configuration, the provided compensation element 15 has the same structure and size as the detection element 1.

Because the compensation element 15 does not have the hydrogen combustion catalytic activity, the hydrogen gas is not combusted in the compensation element 15 even if the compensation element 15 is heated to the same temperature as the detection element 1, hence a temperature increase in the compensation element 15 is not caused by the combustion heat. Moreover, the compensation element 15 is formed of the same material as the detection element 1 and thus has the same temperature-resistance characteristics as the detection element 1. Therefore, a change in resistance value of the detection element 1 that is induced by the combustion heat can be measured accurately by correcting a change in atmospheric temperature or other atmospheric condition by means of a resistance value of the compensation element 15, thereby leading to improvement of hydrogen gas detection accuracy.

The hydrogen gas sensor of the present embodiment is provided with three stems 10a, 10b, 10c. The terminal parts 7 of the detection element 1 and terminal parts 16 of the compensation element 15 are connected to the two stems 10a, 10b, 10c. Although one of the terminal parts 7 of the detection element 1 and one of the terminal parts 16 of the compensation element 15 are connected to the separate stems 10a, 10c respectively, the other terminal part 7 of the detection element 1 and the other terminal part 16 of the compensation element 15 are connected to the same stem 10b. The terminal parts 7 of the detection element 1 and the terminal parts 16 of the compensation element 15 are connected to the measuring circuit via these stems 10a, 10b, 10c.

Note in the present embodiment that because the detection element 1 and the compensation element 15 are stored in the same case, the atmospheric conditions of the detection element 1 and of the compensation element 15 can be conformed to each other and the output of the detection element 1 can be corrected accurately by means of the resistance value of the compensation element 15. However, the detection element 1 and the compensation element 15 may be stored in separate cases as long as the atmospheric conditions of the detection element 1 and of the compensation element 15 can be confirmed to each other.

(Measuring Circuit)

An example of the measuring circuit applicable to each of the above embodiments is shown in FIG. 7.

In this measuring circuit a bridge circuit is formed by the detection element 1, the compensation element 15 and fixed resistances 17, 18. A change in resistance value of the heating resistor 4 is obtained by measuring voltage Vc between output terminals c, d of the bridge circuit to detect hydrogen gas concentration from this change in resistance value.

Although the temperature characteristics and the humidity characteristics of the compensation element 15 are substantially the same as those of the detection element 1 as described above, the compensation element 15 does not respond to the hydrogen gas due to the absence of the combustion activity on the hydrogen gas. The bridge circuit shown in FIG. 7, comprises a series combination of the detection element 1 and the compensation element 15 across terminals a, b, and a series combination of the fixed resistances 17, 18, across terminals a and b. And, a variable resistance 19 for adjusting equilibrium is connected between the terminals a, b. And an intermediate tap of the variable resistance 19 is connected to a node between the fixed resistances 17, 18. A direct-current power sources E1 is connected in series a switch SW and a variable resistance 20 across the terminals a, b. Therefore, a voltage being applied across the terminals a, b is regulated by adjustment of the resistance of the variable resistance 20.

In this measuring circuit, a current passing through the sensing part 2 varies by adjustment of the variable resistance 20 to regulate an amount of heat produced. Consequently, the resistance values of the variable resistance 20 is adjusted in an atmosphere containing no hydrogen gas to heat the sensing part 2 to a predetermined temperature, and variable resistance 19 is adjusted to maintain the equilibrium state of the bridge circuit. Thereafter, when the hydrogen gas arrives at the sensing part 2, the hydrogen gas is burnt and the electric resistance of the heating resistor 23 increases. On the other hand, since the compensation element 15 does not have the activity of a hydrogen combustion catalyst, the hydrogen gas is not burnt in the compensation element 15 and electric resistance of the compensation element 15 does not change. Therefore, a difference of electric resistance is produced between the detection element 1 and the compensation element 15, and a bridge voltage is generated between the output terminals c, d. Since this bridge voltage is proportion to the gas concentration of the hydrogen gas, the gas concentration of the hydrogen gas is detected by this bridge voltage.

Although the above has described the embodiments of the present invention, it is apparent that the present invention can be structured into various forms without departing from the spirit and scope of the present invention. Therefore, the present invention is not limited to a specific embodiment other than the accompanying claims.

### EXAMPLES

Hereinafter, the present invention is described in further detail using examples.

### Example 1

A platinum wire of 20 μm diameter was shaped into a coil having a coil diameter of 200 μm, a coil length of 450 μm and ten turns, to form the sensing part 2 composed only of the heating resistor 4. An aqueous chloroplatinic solution having a concentration of 30 g/L was applied to the surface of the heating resistor 4, and the heating resistor 4 was burned at approximately 800° C. to improve the catalytic activity of the surface of the heating resistor 4.

On the other hand, silica-gel powder (having a specific surface area of 600 m²/g and a pore diameter of 10 nm) that was classified to a particle size of from 0.3 to 3 μm was weighed by 1.0 g, and the aqueous chloroplatinic solution was weighed by 0.2 g in terms of platinum. The silica-gel powder and the aqueous chloroplatinic solution were mixed together, followed by evaporation of the moisture of this mixture, and then the resulting product was burned in an electric furnace at 600° C. for 10 minutes. The obtained product was ground in a mortar and added with a 0.3 cm³ silica sol and an appropriate amount of water to prepare a paste-like mixture.

The mixture prepared in a manner described above was applied to the periphery of the sensing part 2 to cover the entire sensing part 2. After dried in air, this sensing part 2 covered with the mixture was burned in the electric furnace at 600° C. for 5 minutes, whereby the spherical silicon trapping body 3 having an outer diameter of 0.6 mm and a platinum content of 17 wt % was formed.

In this manner, the detection element 1 having the structure described in the first embodiment was formed.

### Examples 2 to 5

As the silica-gel powder, silica-gel powder with pore diameters of 3 nm, 6 nm, 30 nm and 60 nm were used in Example 2, Example 3, Example 4 and Example 5, respectively. Except for these structures, the detection element 1 having the same structure described in the first embodiment was formed in the same manner as in Example 1.

### Example 6

The same sensing part 2 as the one in Example 1 was formed.

As the fine organic particles, a 50 wt % acetylcellulose having a particle size of approximately 1 μm is mixed into an alumina sol to prepare a mixture. This mixture was applied to the periphery of the sensing part 2 to cover the entire sensing part 2, and the resulting product was burned at 1000° C. to form the heat insulating body 6 having a porosity of 50%, a short diameter of 0.3 mm, and a long diameter of 0.5 mm.

The silicon trapping body 3 containing platinum and activated carbon was formed on an outer surface of this heat insulating body 6 by using the same technique as in Example 1 to form a sphere having an outer diameter of 0.85 mm.

In this manner, the detection element 1 having the structure described in the second embodiment was formed.

### Example 7

The same sensing part 2 as the one in Example 1 was formed.

Silica-gel powder (having a specific surface area of 600 m²/g and a pore diameter of 10 nm) that was classified to a particle size of from 0.3 to 3 μm was weighed by 1.0 g, and the aqueous chloroplatinic solution was weighed by 0.2 g in terms of platinum. The silica-gel powder and the aqueous chloroplatinic solution were mixed together, followed by evaporation of the moisture of this mixture, and then the resulting product was burned in an electric furnace at 600° C. for 10 minutes. The obtained product was ground in a mortar and added with a 0.3 cm³ silica sol and an appropriate amount of water to prepare a paste-like mixture A.

Moreover, a paste-like mixture B was prepared in the same manner as the mixture A, except that the amount of aqueous chloroplatinic solution used was set at 0.5 g in terms of platinum.

The mixture A was applied to the periphery of the sensing part 2 to cover the entire sensing part 2 as in Example 1. After dried in air, the mixture A was burned in the electric furnace at 600° C. for 5 minutes, whereby a first body having a short diameter of 0.3 mm, a long diameter of 0.4 mm, and a platinum content of 17 wt % was formed.

Next, the mixture B was applied to the periphery of the first body to cover the entire first body. After dried in air, the mixture B was burned in the electric furnace at 600° C. for 5 minutes, whereby a second body having a platinum content of 33 wt % was formed. As a result, the spherical silicon trapping body 3 composed of the first body and the second body and having an outer diameter of 0.6 mm was formed.

In this manner, the detection element 1 having the structure described in the first embodiment was formed.

### Example 8

The same sensing part 2 as the one in Example 1 was formed.

Granular activated carbon having a specific surface area of 1000 m² was ground and crushed into fine particles in a mortar. Water and an alumina sol were added to this fine granular activated carbon to prepare a paste-like mixture.

This mixture was applied to the periphery of the sensing part 2 to cover the entire sensing part 2, which was then burned at 350° C. As a result, the spherical silicon trapping body 3 having an outer diameter of 0.85 mm and an activated carbon content of 95 wt % or above was formed.

In this manner, the detection element 1 having the structure described in the first embodiment was formed.

### Example 9

The same sensing part 2 as the one in Example 1 was formed.

Granular activated carbon having a specific surface area of 1000 m² was ground into fine particles in a mortar. An aqueous chloroplatinic solution was added to this fine granular activated carbon, followed by removable of the moisture of the fine granular activated carbon, and the resulting fine granular activated carbon was heated at 350° C., whereby platinum was carried in the fine granular activated carbon. Next, water and an alumina sol were added to this fine granular activated carbon carrying platinum, to prepare a paste-like mixture.

This mixture was applied to the periphery of the sensing part 2 to cover the entire sensing part 2, which was then burned at 350° C. As a result, the spherical silicon trapping body 3 having an outer diameter of 1 mm and a platinum content of 5 wt % was formed.

In this manner, the detection element 1 having the structure described in the first embodiment was formed.

### Example 10

The same sensing part 2 as the one in Example 1 was formed.

As the fine organic particles, a 50 wt % acetylcellulose having a particle size of approximately 1 μm is mixed into an alumina sol to prepare a mixture. This mixture was applied to the periphery of the sensing part 2 to cover the entire sensing part 2, and the resulting product was burned at 1000° C. to form the heat insulating body 6 having a porosity of 50%, a short diameter of 0.3 mm, and a long diameter of 0.5 mm.

The silicon trapping body 3 containing platinum and activated carbon was formed on the outer surface of this heat insulating body 6 by using the same technique as in Example 9 to form a sphere having an outer diameter of 0.85 mm.

In this manner, the detection element 1 having the structure described in the second embodiment was formed.

### Comparative Example 1

Except for that the silicon trapping body 3 was not formed, the detection element 1 was formed in the same manner as in Example 1. Specifically, the detection element 1 was formed from only the sensing part 2 of Example 1.

(Hydrogen Detection Sensitivity Evaluation Test)

The detection element 1 that was obtained in each of the examples, including Comparative Example 1, was connected to the measuring circuit shown in FIG. 7. In this measuring circuit, the variable resistance 19 was adjusted while a voltage of 0.2 V being applied to the detection element 1 and the compensation element resistance, to maintain the equilibrium state of the bridge circuit. The preset temperature of the sensing part 2 in this case was approximately 110° C.

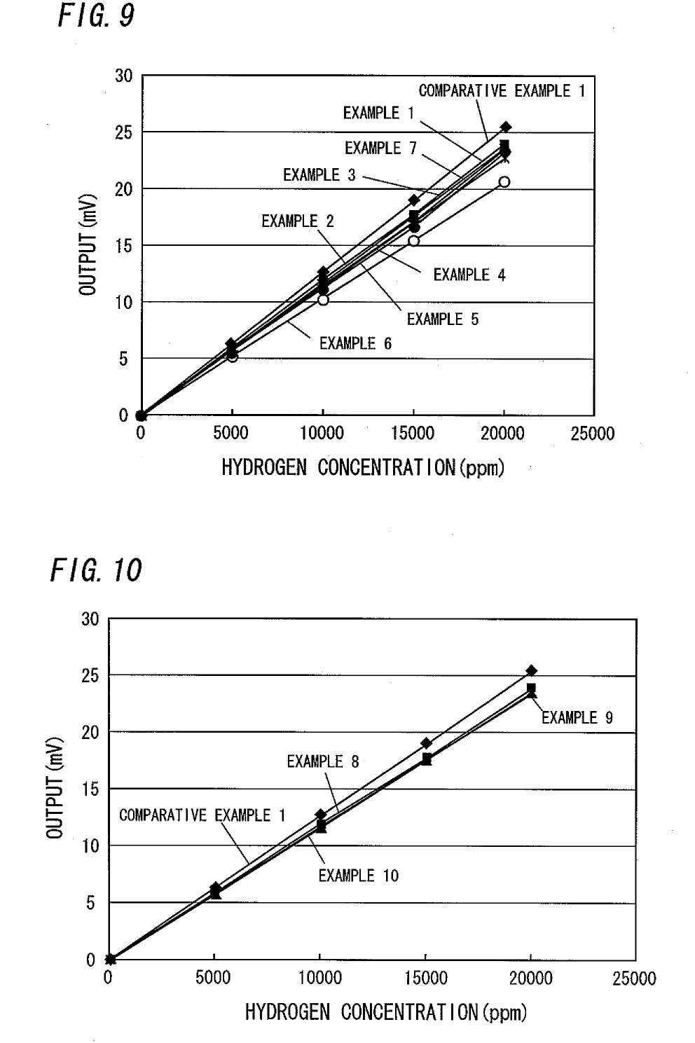

The detection element 1 and the compensation element 15 of each of the examples and the comparative example were exposed to the target gas that contains hydrogen gas, in order to measure a change in bridge voltage (bridge output) in relation to the hydrogen concentration. The results of the measurement are shown in FIG. 9 and FIG. 10.

As a result, the hydrogen gas detection sensitivity in each example was equal to the detection sensitivity in Comparative Example 1.

(Evaluation Test on Silicon Compound-Tolerance)

The detection element 1 that was obtained in each of the examples, including Comparative Example 1, was connected to the measuring circuit shown in FIG. 7. In this measuring circuit, the variable resistance 19 was adjusted while a voltage of 0.2 V being applied to the detection element 1 and the compensation element 15, to maintain the equilibrium state of the bridge circuit. The preset temperatures of the sensing part 2 of the detection element 1 and of the compensation element resistance in this case were approximately 120° C.

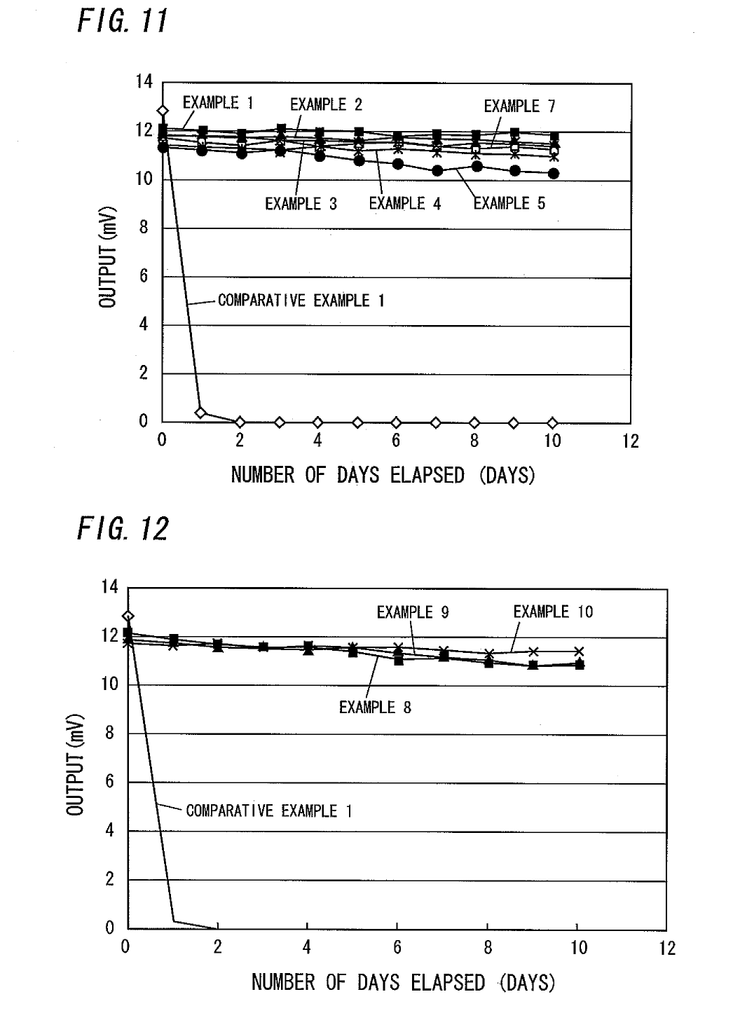

The detection element 1 and the compensation element 15 of each of the examples and the comparative example were exposed to gas containing 1000 ppm hexamethyldisiloxane and 5000 ppm hydrogen for 10 days while being energized, thereby poisoning the detection element 1 by silicon compound. In the meantime, the detection element 1 was exposed in gas containing 10000 ppm hydrogen gas but no hexamethyldisiloxane one time a day. Note that, in this experiment where the atmosphere containing hexamethyldisiloxane and hydrogen and the atmosphere containing hydrogen but no hexamethyldisiloxane are alternately replaced with each other, when replacing the atmosphere containing hydrogen but no hexamethyldisiloxane with the atmosphere containing hexamethyldisiloxane and hydrogen, the concentration of the hexamethyldisiloxane within the atmosphere was reduced to approximately 100 ppm in approximately two to three hours, hence the actual concentration of the hexamethyldisiloxane within this atmosphere is estimated to be an average of approximately 100 ppm. The bridge voltage obtained in this circumstance was measured. The results are shown in FIG. 11 and FIG. 12.

As a result, no significant decrease in hydrogen detection sensitivity was observed in Examples 1 to 10, while the hydrogen detection sensitivity was decreased so significantly in almost no time that the detection of hydrogen was impossible in Comparative Example 1.

Moreover, of Examples 1 to 5 in which the pore diameter of the silica particle used for forming the silicon trapping body 3 was changed, in Examples 1 to 4 in which the pore diameter is in the range of 3 to 30 nm, the decrease in hydrogen detection sensitivity was small compared to Example 5 in which the pore diameter was 60 nm.

(Evaluation of Temperature Characteristics)

The same test as the hydrogen detection sensitivity evaluation test described above was performed in Examples 8 to 10, except that a voltage of 0.4 V was applied to the detection element 1 and the compensation element 15. In this case, the preset temperatures of the sensing part 2 of the detection element 1 and the compensation element 15 are approximately 240° C.

The results are shown in FIG. 13 along with the results of the hydrogen detection sensitivity evaluation test performed in Examples 8 to 10. In FIG. 13 the results obtained when the operating voltage was 0.2 V are marked with “(low temperature)” and the results obtained when the operating voltage was 0.4 V are marked with “(high temperature).”

As a result, in Examples 8 to 10, the results obtained when the operating voltage was 0.4 V all show large detection output value and gradient and high hydrogen detection sensitivity.

Also, in Examples 1, 6 and 8 to 10, the hydrogen gas sensor was operated at the operating voltage of 0.2 V (preset temperature, approximately 120° C.), 0.3 V (preset temperature, approximately 180° C.), 0.4 V (preset temperature, approximately 240° C.), 0.5 V (preset temperature, approximately 320° C.), and 0.6 V (preset temperature, approximately 420° C.) respectively. The evaluation test on silicon compound-tolerance described above was performed in the each case.

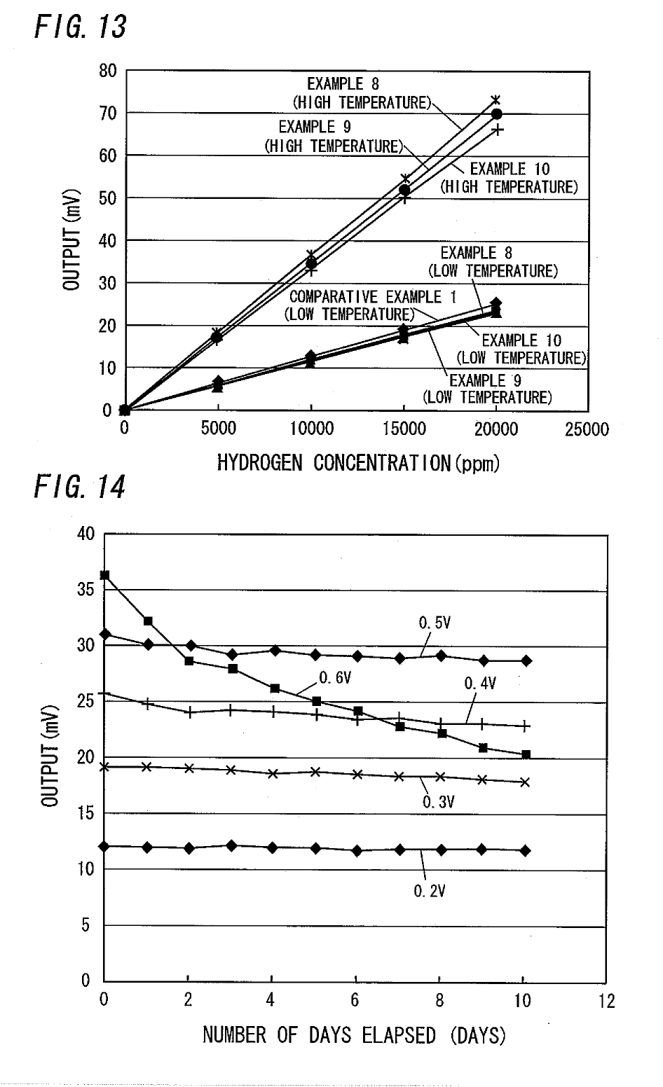

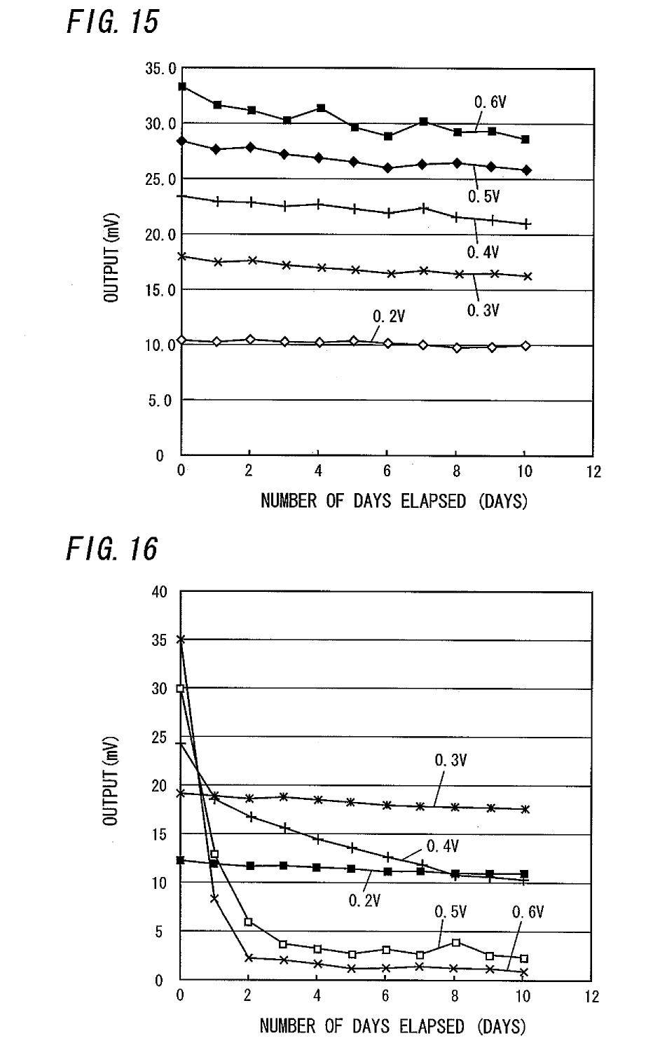

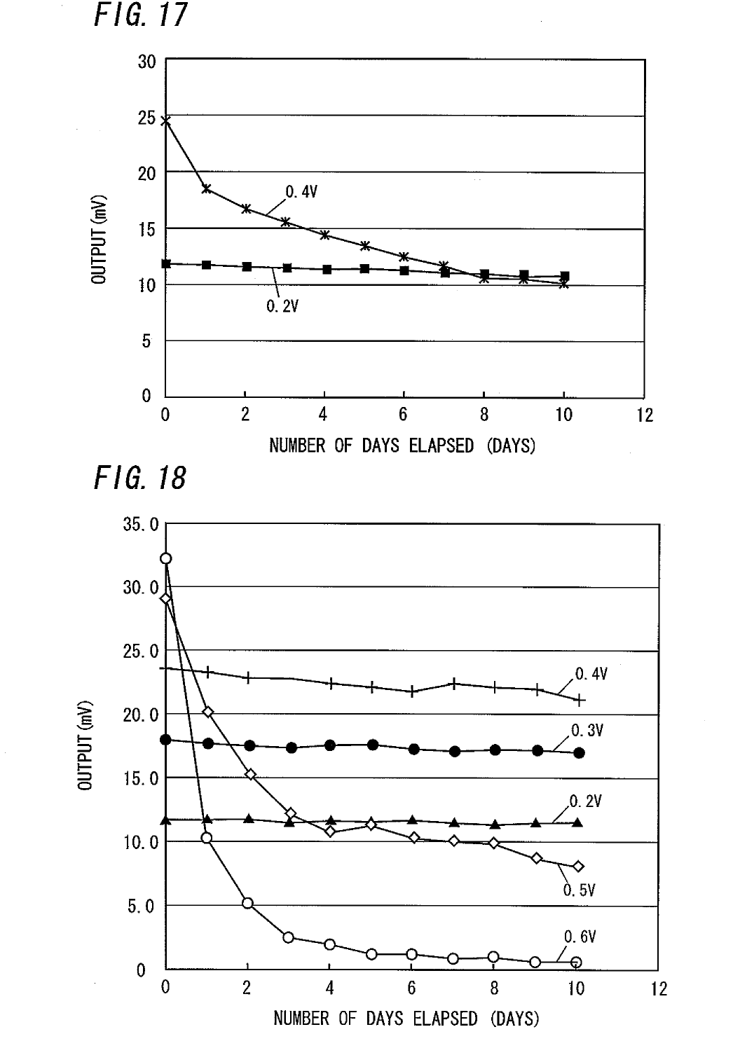

The results of Example 1 is shown in FIG. 14, the results of Example 6 in FIG. 15, the result of Example 8 in FIG. 16, the result of Example 9 in FIG. 17, and the result of Example 10 in FIG. 18.

As a result, although the detection element 1 is not poisoned by silicon compound up to an operating voltage of 0.5 V in Example 1, it starts being poisoned by silicon compound after 0.6 V. It is considered because of the degradation of the capability of the silicon trapping body 3 that is caused by alteration of the platinum component within the silicon trapping body 3 due to the heat generated from the sensing part 2. On the other hand, in Example 6 in which the heat insulating body 6 is provided, no significant decrease in detection sensitivity was observed even at the operating voltage of 0.6 V.

In addition, the silicon compound-tolerance started degrading at an operating voltage of 0.4 V in Examples 8 and 9. It is considered because of the degradation of the capability of the silicon trapping body that is caused by alteration of the activated carbon due to the heat. On the other hand, in Example 10 in which the heat insulating body 6 is provided, no impact of the silicon poisoning was observed even at an operating voltage of 0.4 V, but the silicon compound-tolerance started degrading at an operating voltage of 0.5 V.

1. A catalytic combustion type hydrogen gas sensor, comprising a detection element having a sensing part and a silicon trapping body,
wherein the sensing part is a heating resistor which consists of a noble metal coil having a hydrogen combustion catalytic activity surface, and has a function of being heated by Joule heat generated by energization of the sensing part, a function of combusting hydrogen gas while being heated, and a function of outputting a change in electrical resistance of the sensing part indicative of hydrogen gas concentration, the change in electrical resistance being caused by an increase in temperature of the sensing part caused by the combustion heat of the hydrogen gas, and
wherein the silicon trapping body covering the sensing part in direct contact therewith comprises a silica particle sintered porous body which contains platinum as a silicon-trapping material that functions to trap a silicon compound from a gaseous matter passing through the silicon trapping body.

2. (canceled)

3. (canceled)

4. (canceled)

5. (canceled)

6. (canceled)

7. (canceled)

8. The hydrogen gas sensor according to claim 1, wherein a pore diameter of the silica particle is in the range of 3 to 30 nm.

9. (canceled)

10. (canceled)

11. The hydrogen gas sensor according to claim 1, further comprising a measuring circuit for applying voltage to the sensing part to set a preset temperature of the sensing part in the range of 110 to 350° C.

12. (canceled)

13. (canceled)

14. (canceled)

15. (canceled)

16. (canceled)

17. The hydrogen gas sensor according to claim 8, further comprising a measuring circuit for applying voltage to the sensing part to set a preset temperature of the sensing part in the range of 110 to 350° C.

18. The hydrogen gas sensor according to claim 1, wherein the platinum content in each silicon trapping body is in the range of 5 to 30 wt %.

19. The hydrogen gas sensor according to claim 8, wherein the platinum content in each silicon trapping body is in the range of 5 to 30 wt %.

20. The hydrogen gas sensor according to claim 11, wherein the platinum content in each silicon trapping body is in the range of 5 to 30 wt %.

21. The hydrogen gas sensor according to claim 1, wherein the outer diameter dimension of the silicon trapping body is in the range of 0.3 to 1 mm.

22. The hydrogen gas sensor according to claim 8, wherein the outer diameter dimension of the silicon trapping body is in the range of 0.3 to 1 mm.

23. The hydrogen gas sensor according to claim 11, wherein the outer diameter dimension of the silicon trapping body is in the range of 0.3 to 1 mm.

24. The hydrogen gas sensor according to claim 17, wherein the outer diameter dimension of the silicon trapping body is in the range of 0.3 to 1 mm.
